(19) United States
(12) Patent Application Publication
(10) Pub. No.: US 2012/0188404 A1
(43) Pub. Date: Jul. 26, 2012

(54) Enhanced Timer Functionality for Camera Systems

(76) Inventors: Mikko Muukki, Tampere (FI); Hannu Kakkori, Tampere (FI); Lasse Juhani Kantola, Kawaguchi-shi (JP); Peter West, Hants Hampshire (GB); Juha Alakarhu, Helsinki (FI); Eero Salmelin, Tampere (FI)

(21) Appl. No.: 13/381,835

(22) PCT Filed: Jun. 30, 2009
(86) PCT No.: PCT/FI2009/050590

§ 371 Date: Apr. 9, 2012

(51) Int. Cl. H04N 5/235

(52) U.S. Cl. 348/229.1; 348/E05.037

(57) ABSTRACT

This solution relates to a camera system including an enhanced timer functionality in a camera module. The enhanced timer functionality includes defining a first synchronization point triggering a first set of exposing functionalities by a sensor internal signal as a response to a first command, and controlling the exposure internally according to said first synchronization point.

### TECHNICAL FIELD

This disclosure relates to a camera system comprising an enhanced timer functionality.

### BACKGROUND

In camera systems, global shutters can be used for ending the exposure simultaneously throughout the image. The global shutter can be implemented either electrically or mechanically. If a global shutter (i.e. mechanical shutter or electrical) is used in a camera having a flash, precise timing accuracy is required from the host system. Global reset signal resets all the pixels (charge values) simultaneously, before the exposure of the image begins. Image exposure ends by means of ending exposure simultaneously or almost simultaneously e.g. by closing the mechanical shutter or by using electrical global shutter. Typically a timing unit connected to the camera sensor controls all the imaging functions. The global-reset command is often implemented by means of two external signals.

An example of a solution of related art is disclosed in publication WO 2007/065964 A1. The document discloses a method where the host module is responsible for the main commands of the imaging sequence. The host module initiates imaging by creating an external global reset (GRST) signal. The entire imaging sequence is synchronized with this signal. The host module knows the delay from the GRST to the start of imaging and from the GRST to the start of image reading. In this way the host module can trigger the flash and close the mechanical shutter at the correct moment.

### SOME EXAMPLE EMBODIMENTS

The present solution relates to a camera system, where timer functionality is carried out in the camera head side instead of a host system. This reduces the amount of I/O pins between the host and the sensor and reduces dependency on control bus properties. In addition, the camera system is not targeted to mechanical shutters only, but is usable with electrical shutter i.e. rolling and global shutters also.

According to an example, an apparatus comprises a camera module comprising at least an image sensor and a shutter; a host configured to control the camera module; and a flash. The image sensor is configured to define a first synchronization point triggering a first set of exposing functionalities by a sensor internal signal as a response to a first command; and the camera module is configured to control the exposure internally according to said first synchronization point,

According to an example, a method comprises defining a first synchronization point triggering a first set of exposing functionalities by an image sensor internal signal as a response to a first command, and controlling the exposure internally according to said first synchronization point.

According to an example, a computer program product comprising executable instructions that, in response to execution by a processor, are adapted to perform defining a first synchronization point triggering a first set of exposing functionalities by an image sensor internal signal as a response to a first command, and controlling the exposure internally according to said first synchronization point.

According to an example, a method comprises using at least two set of flash pulses comprising at least one flash pulse for each frame, wherein the method further comprises using the at least two sets of pulses for exposure times, so that the overall energy of the at least two set of pulses during one or more exposure time is linearly proportional to the length of the exposure times.

According to yet another example the host is configured to send a second command defining a second synchronization point triggering a second set of exposing functionalities.

According to yet another example a set of exposing functionalities comprises one or more of the following: global shutter, neutral density filter, iris of a lens, flash module.

According to yet another example the host is configured to define the time between the first and the second synchronization points.

According to yet another example, the camera module is configured to terminate a frame if the sensor receives a command between start of an image frame and end of the image frame.

According to yet another example, the camera module is configured to terminate the frame to where the first synchronization point is defined.

According to yet another example, the frame termination method depends on where the sensor is in the frame that is being read out when the command is received.

According to yet another example, the camera module is configured to terminate the frame by a frame end packet if a previous packet was not a frame end packet.

According to yet another example, the flash is a xenon flash.

According to yet another example, the flash is a LED flash.

According to yet another example, at least two set of flash pulses for each frame are used, where the set of flash pulse consists at least one flash pulse.

According to yet another example, wherein a first set of pulses is used for long exposure and a second set of pulses is used for short exposure.

According to yet another example, the overall energy of the two set of pulses during each exposure time is proportional to the length of the exposure time.

According to yet another example, wherein the overall energy of said at least two set of flash pulses during one or more exposure times is linearly proportional to the length of exposure times.

According to yet another example, shutter is one of the following: a rolling shutter, an electrical global shutter or a mechanical shutter.

According to yet another example, the apparatus is a mobile phone further comprising means for telecommunication.

According to yet another example, the apparatus is a digital camera.

The present solution of moving timer functionality to camera head side makes it possible to synchronize all timings to camera internal operation with great accuracy. The system controller sets up these timers. Advanced exposing functionalities make it possible to have e.g. mechanical shutter, iris, ND-filter and flash control with good accuracy without need of strict and difficult requirements from host software and hardware.

### DESCRIPTION OF THE DRAWINGS

The present solution is described in more detailed manner in the following with references to drawings, where

FIG. 1 illustrates an example of a camera system,

FIG. 2 illustrates an example of long exposure mode without frame termination,

FIG. 3 illustrates an example of long exposure mode with frame termination,

FIG. 4 illustrates an example of flash strobe in xenon flash rolling shutter use case,

FIGS. 5a,b illustrate the difference between a problematic case and a standard operation when short xenon flash strobe is combined with double exposure,

FIG. 6 illustrates an example of dual xenon flash pulses, where the energy of each pulse is proportional to the length of the exposure period during which the xenon pulse occurs,

FIG. 7 illustrates an example of a situation of FIG. 6, where the exposure times overlap, and

FIG. 8 illustrates an example of an apparatus comprising the camera system.

### DESCRIPTION OF EXAMPLE EMBODIMENTS

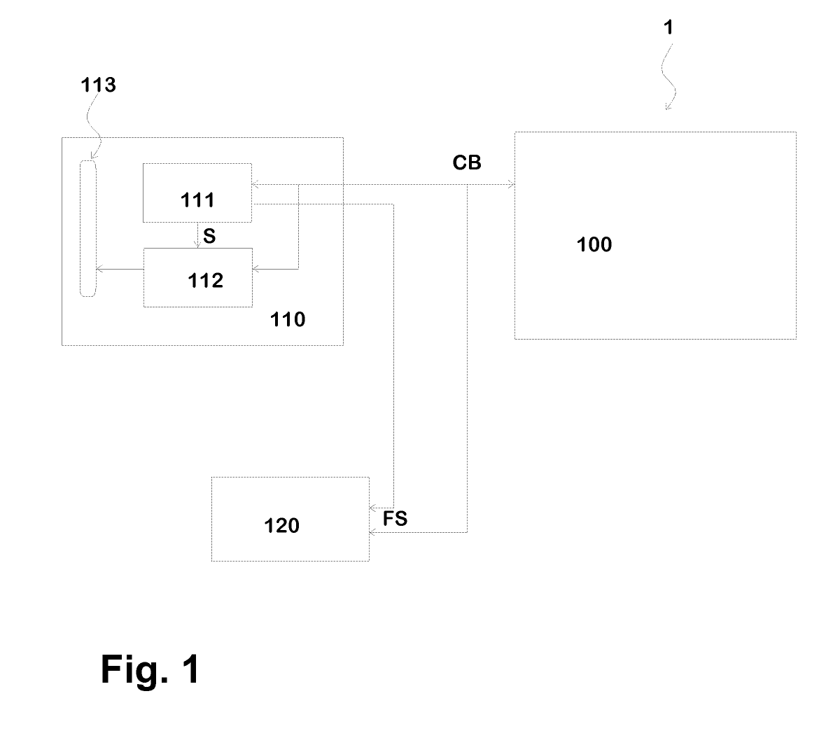

In FIG. 1 an example of a camera system is illustrated. It is appreciated that this kind of structure is only an example, and other topologies of command bus can be possible. The camera system comprises at least a host 100 and a camera module 110. The camera module 110 comprises at least an image sensor 111, a lens driver 112 and a lens 113. The image sensor 111 can be CMOS sensor (Complementary Metal Oxide Semiconductor). The camera system also comprises a flash 120 (Xenon or LED). The host 100 is configured to control the camera module 110 through a control bus “CB”. The control bus “CB” may be CCI (Camera Control Interface). The control bus may also be based on UniPro or Slimbus (both MIPI interfaces), but in those cases, the topology is different.

In the present example. the camera module can have a mechanical shutter that supports global reset modes, such as long exposure times with or without frame termination. The camera module may also have a rolling shutter. A timer functionality of the present solution is arranged to the sensor 111. This kind of arrangement removes dependency on host properties and does not require strict timing with respect to host software.

For example, in the solutions of related art, the timing functionality has been located on host or system controller side. In such systems, timings are synchronized to camera interface receiver activities, but the controllability is still dependent on host software details and capabilities. In solutions of related art, the capabilities are not often good enough for advanced usages nor they support easily interfaces where receiver activities are not directly synchronized to camera activity e.g. UniPro based interfaces. Mechanical shutter control has been relaying on host timers, which means that the synchronization signal has been between host and camera.

In the present solution, the lens driver 112 is configured to control, for example, the shutter. Shutter strobe signal “S” between the sensor 111 and the lens driver 112 is used for synchronization. The lens driver 112 can be also integrated to a sensor chip, but also in that case similar logical connections exist.

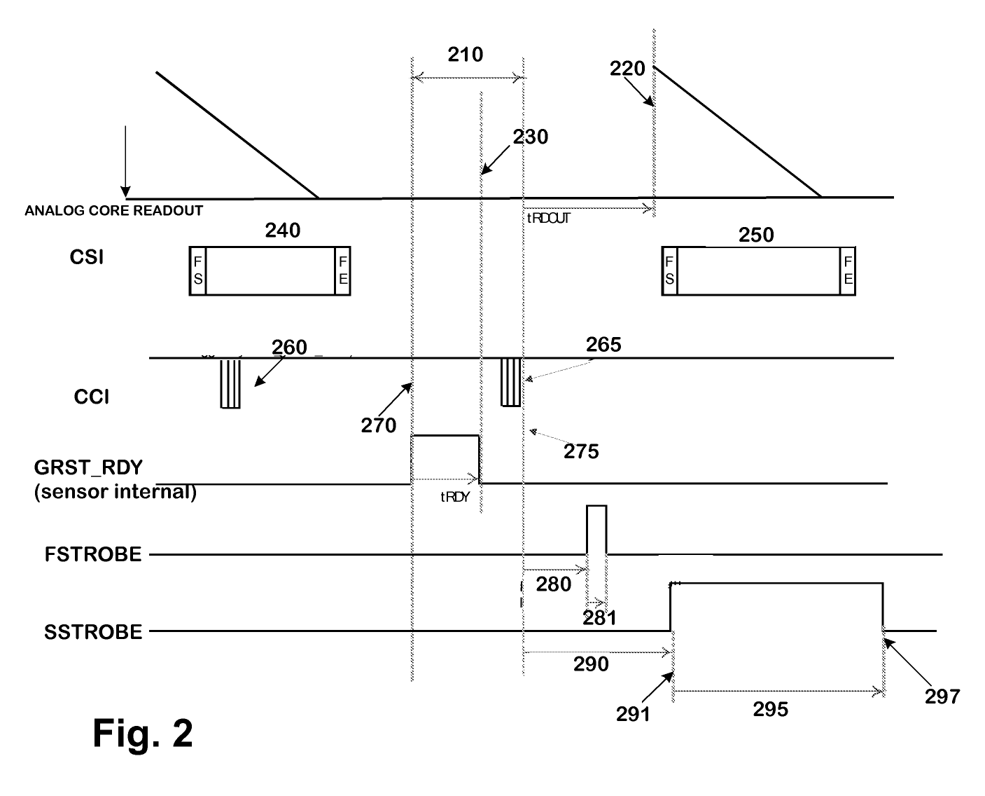

When the image is captured with a mechanical shutter, the host 100 will set timer registers on the sensor 111. The host 100 will also configure lens driver 112 to control the shutter based on the shutter strobe signal “S”. For starting the global reset sequence, the host requests global reset operation from the camera module via CCI command (see FIG. 2). The command may occur either during frame output or blanking period.

Global reset operation resets all the pixels of the image at the same time. Global reset is used to take still images with a mechanical shutter. Exposure is started after the global reset and stopped by closing the mechanical shutter. It is also possible that exposure is ended with electrical global shutter. However, in that case there is no mechanical shutter driver, even though the logical operation may be the same.

If xenon flash 120 is used, also xenon flash driver is configured to control xenon flash 120 based on flash strobe signal “FS”. Image exposure is started by e.g. CCI command, and timer functionality will control rest of the events. Xenon flash is fired during the exposure with suitable power based on placement and width of flash strobe signal. Shutter is closed by the shutter strobe signal and it can be opened by the shutter strobe signal.

The present application introduces an enhanced timing functionality where
A) a long exposure mode (with or without frame termination) having a free range for extending the maximum exposure time is described; and where
B) a flash strobe can be used with rolling shutter and global reset; and
C) two xenon flash pulses can be used for each frame.

A) Long Exposure Mode

FIG. 2 illustrates a timing example of long exposure mode without frame termination. In this solution, and as a difference compared to solutions of related art, the mode represents a free range 210 controlled by the host. The free range 210 is configured to extend the maximum exposure time. The mode is intended for use with long exposures. After the host has completed the appropriate setups (timing, image size, other information relating to capturing the still frame), a first command 260 to start global reset is given. The first command 260 may be sent by the host. The image sensor indicates the start of the exposure using the sensor internal signal GRST_RDY. The rising edge of tRDY defines the first synchronization point 270 that is the start of the free range 210 and that triggers the first set of exposing functionalities (e.g. global shutter, ND-filter (Neutral Density), iris, flash module). During tRDY, the pixels of the frame are reset, and the exposure 230 will start when tRDY signal goes down. FIG. 2 shows a viewfinder frame 240 and a global reset frame 250.

The host will start its own timer just before, during or after tRDY signal if the exposure time is long. However, if the exposure time is short, the host will start its own timer before or just after tRDY signal depending on how the counter is done (i.e. does it count to the exposure time of the first part or to the exposure time of the first part, from which exposure time the length of tRDY is subtracted). After a suitable time, another command 265 is sent to start the rest of the exposure. The another command 265 may be sent by the host. The time (free range 210) between the performance of these first and second commands can be determined by the host, and can be e.g. 1-10 seconds. The phase resulting from the second command activates tRDOUT and the readout 220 will happen when tRDOUT has expired or with separated command to start the readout. To put it simply, the long exposure time is achieved by writing the appropriate settings, starting the exposure 230 and then starting a new synchronization point 275 defined by the second command 265, which new synchronization point 275 triggers the second set of exposing function. For example, strobe signals (SSTROBE, FSTROBE) may be synchronized to the new synchronization point. Shutter strobe SSTROBE is intended to be used with mechanical shutter. The shutter strobe is connected to mechanical shutter driver, which can be external or internal to camera module. In FIG. 2 also shutter strobe delay 290 is shown. The mechanical shutter is closed some time after rising edge of the SSTROBE signal, and the exposure 291 is ended at the time the mechanical shutter is closed. The width of SSTROBE is indicated by 295. The mechanical shutter may open some time after falling edge 297 of the SSTROBE signal. Signal SSTROBE can also control the exposing functionalities, such as ND-filter and iris of the lens. Flash strobe FSTROBE is intended to be used with different flash solutions, e.g. xenon and led flash. Flash strobe signal is connected to the flash module that can be external to the camera module. FIG. 2 shows flash strobe delay 280 and flash strobe width 281. Strobe control is carried out from the camera module.

As an example of solutions of related art, the synchronization between a mechanical shutter system and an image sensor demands several I/O pins and there is often quite a long delay between the command signal and the actual exposure of the image. Generally, a considerable number of I/O pins are required between the host module and the image sensor. The present solution, where the GRST signal is sensor internal, the number of pins can be reduced.

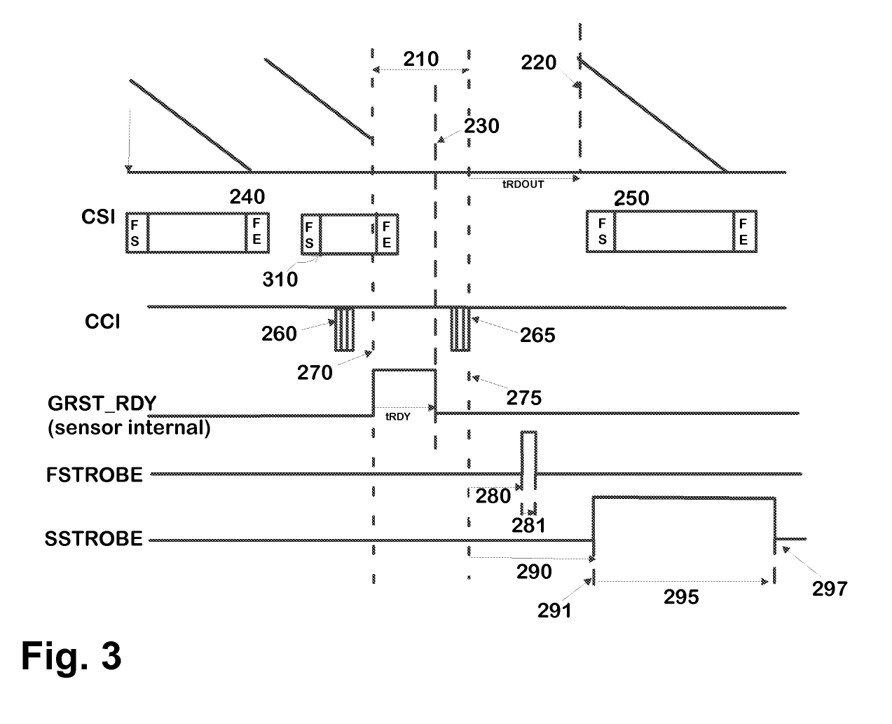

Sensor supports several ways how transition between a rolling shutter and global reset frames happens, with or without frame termination. FIG. 2 illustrates an example without frame termination, and FIG. 3 illustrates the previous example with frame termination. It is realized from the figure that the latter viewfinder image frame (310) is terminated. In the frame termination mode the camera moves from a streaming state to a new state, that can be either a software standby or a new streaming state. Entering software standby state and then restarting streaming can be used to synchronize host and camera module. There are three possibilities for where the sensor may be in the frame that is being read out when the command is received. In the following, two different modes, CCP2 (Compact Camera Port 2) and CSI-2 (Camera Sensor Interface 2), are presented. The CCP2 is based on SMIA (Standard Mobile Imaging Architecture) specification, whereas the CSI-2 is based on MIPI (Mobile Industry Processor Interface) specification. As will be realized, both of these modes have different kind of frame terminations, because they have different bus protocols.

1. Command received during frame blanking
When in CCP2 mode, the behaviour shall be the same as for the standard mode, i.e. the camera module shall immediately enter a new state.
In case of CSI-2, it is assumed the module will already be in an LP (low power) idle state and a new state can be entered immediately.
In generalized interface format: It is assumed that the camera is in idle mode and a new state can be entered immediately.

2. Command received during the active line
When in CCP2 mode: The module shall continue outputting the line information until the end of the current line, including the line end code. Then terminate the frame by transmitting a line start code and a frame end code. The module shall then immediately enter to a new state.
When in CSI-2 mode: The module shall complete the existing packet and terminate the frame with frame end packet if the existing packet was not frame end packet. The module shall then immediately enter to a new state.
In generalized interface format: The module shall complete the existing packet and terminate the frame with end of the frame information. The end of the frame information can be send as a frame end packet or it can be included to the packet structure otherwise. The module shall then immediately enter to a new state.

3. Command received during line blanking
When in CCP2 mode: The module shall terminate the frame by transmitting a line start code and a frame end code. The module shall then immediately enter to a new state.
When in CSI-2 mode: It is assumed that the module is already in an LP idle so that frame can be terminated by sending a frame end packet if previous packet was not a frame end packet. The module shall then immediately enter to a new state.
In generalized interface format: It is assumed that the camera is in idle mode so that frame can be terminated by sending packet telling end of frame. The end of the frame information can be sent as a frame end packet or it can be included to the packet structure otherwise. The module shall then immediately enter to a new state.

This kind of frame termination is aimed for rolling shutter and does not expect global reset circuit or global reset signal as in the publication WO 2007/065964 A1 (previously referred). Same details of frame termination are applicable to global reset mode also, but then the new state is a global reset sequence.

B) Flash Strobe Used with Rolling Shutter

The flash strobe FSTROBE can be used also with rolling shutter with a flash. The flash is typically a xenon flash, but FSTROBE can also be used with LED flash. The status of the strobe signals can be read from embedded data in the frame. This makes it possible that the host software keeps the synchronization with the camera even if there are multiple chips doing the operation without dependency on control bus properties.

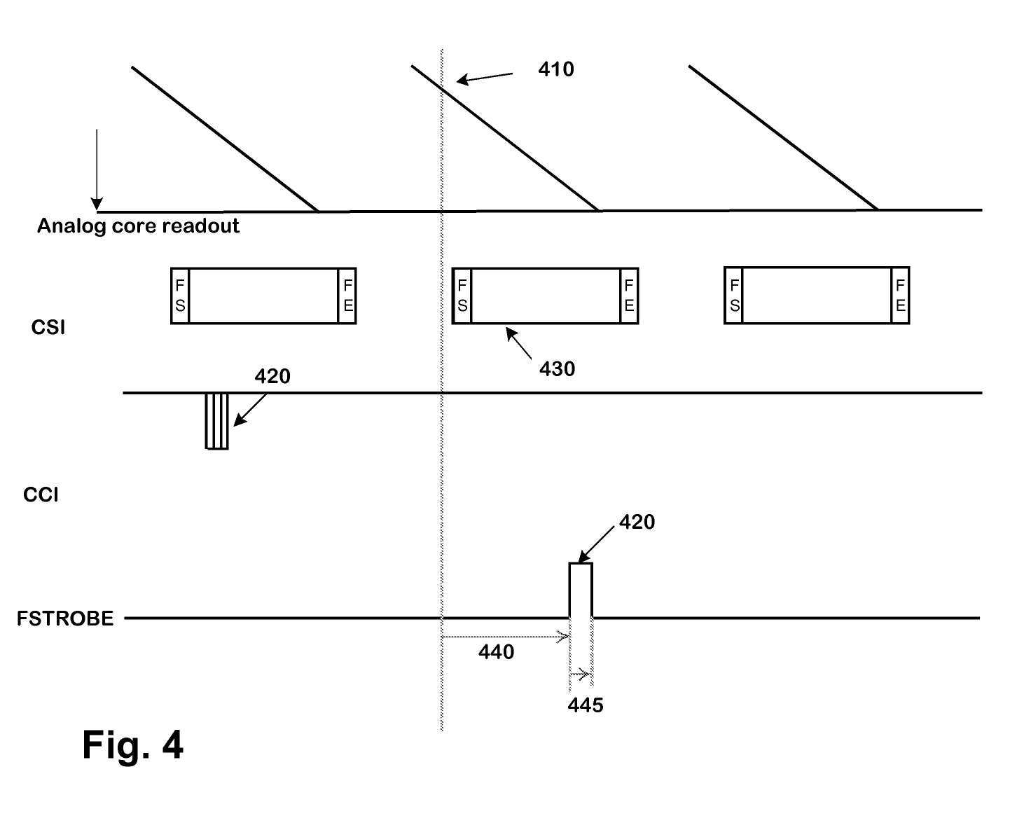

FIG. 4 illustrates an example of flash strobe FSTROBE in xenon flash rolling shutter user case, where request to flash command 420 is received. The accuracy of the flash strobe in the xenon flash case is very critical because 1 μs accuracy needs to be achieved with short pulses. With longer pulses the requirements are not so critical. The length of the flash strobe pulse 445 can be used to control the xenon flash output (the amount of light output), but this is not mandatory. In the rolling shutter mode (FIG. 4), flash strobe can be synchronized to a reference point 410 (in FIG. 2, e.g. to synchronization point 275). The reference point can be the start of exposure of that line. The location of the reference point (410) is programmed to indicate when a certain line starts to get exposed. Similar functionality may be achieved by using the start of readout as a reference point of proper line with possible suitable delay value. The rising edge of flash strobe can be delayed 440 in the rolling shutter mode. The xenon flash strobe is fired (420) based on FSTROBE signal. At the beginning of each frame, there are embedded data indicating the frame during which the strobe has been triggered (430). Xenon flash is typically fired when all image lines are exposing.

It is also possible to fire xenon flash in a way when only part of the image lines are exposing. This may be beneficial when the frame comprises an autofocus window or a face detection window.

C) Two Xenon Flash Pulses for Double Exposure

As a further embodiment, two sets of flash pulses may be used for each frame. The flash pulse may be xenon flash pulse or LED flash pulse. In addition, a set of flash pulses may comprise at least one flash pulse. One set of pulses is used for long exposure and the other is for short exposure. In the double exposure, the longer integration time (i.e. longer exposure time) is for capturing darker shades and the shorter integration time (i.e. shorter exposure time) is for capturing brighter shades of the image. The dual pulses are used so that the energy of each pulse is proportional to the length of the exposure period during which the xenon pulse occurs. Energy of a long exposure pulse set is greater than energy of a pulse set related to the short exposure.

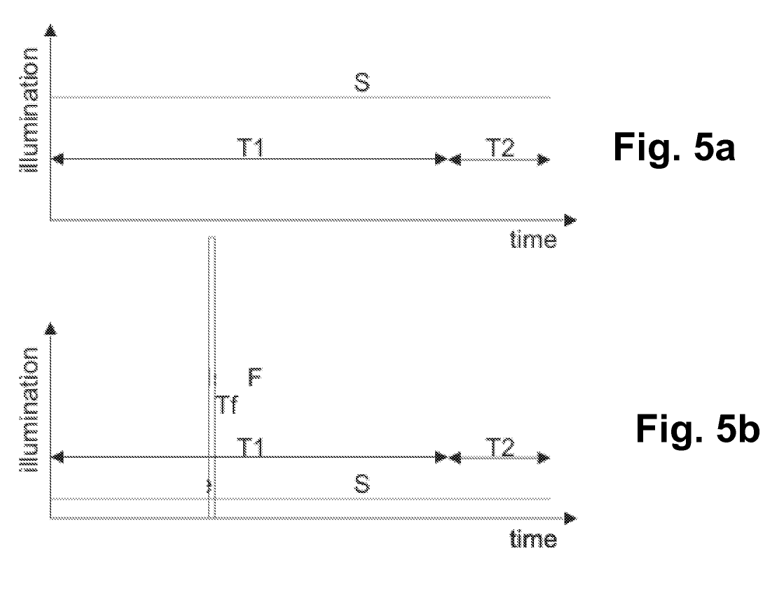

It has been realized from the related art that when a very short xenon flash strobe is combined with double exposure, the double exposure wide dynamic range sensor assumes that the exposure of all pixels stays unchanged or nearly unchanged during both exposure. FIG. 5 illustrates how the problematic case (FIG. 5b) differs from the standard operation (FIG. 5a). In the standard case (FIG. 5a), the scene illumination has intensity S and the exposure for the long integration time is T1*S and the exposure for the short integration time is T2*S. Thus, the pixel output for short and long exposure times are linearly proportional to the duration of the integration time. In the problem case, the exposure for the long integration time is (F*Tf)+(S*T1), where F is flash pulse and Tf is time of the flash pulse, and the exposure for the short integration time is S*T2. Thus, the pixel outputs are not proportional to the exposure times and wide dynamic range system does not work.

The incompatibility of the xenon flash with wide dynamic range sensor is a major drawback, because the lack of dynamic range is often very visible in images captured with xenon flash (e.g. face of a person in the photo becomes completely white while the background is very dark). The problem does not occur with current led flash implementations because in those the led illumination stays constant over the whole exposure time. However, if future led flash implementations are more xenon-like (short bright pulse), also they may have the same problem.

As already mentioned, the solution for the problem is to use dual (xenon/LED) flash pulse sets F1, F2 so that the energy of each pulse set is proportional to the length of the exposure period during which the xenon pulse set occurs. The energy of pulse set occurring during long exposure time is T1/T2 times the energy of the pulse set occurring during the short exposure time. T1 is the duration of the long exposure time and T2 is the duration of the short exposure time.

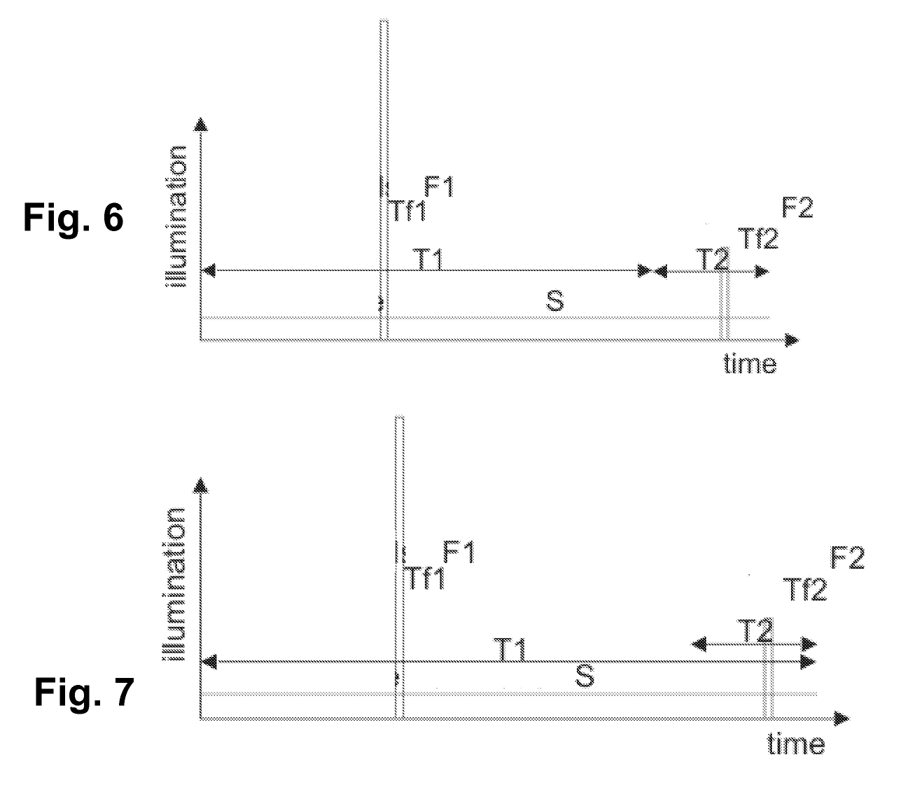

FIG. 6 illustrates this solution. The exposure of the long integration time is (T1*S)+(Tf1*F1) and the exposure of the short integration time is (T2*S)+(Tf2*F2), thus (Tf1*F1)/(Tf2*F2)=T1/T2. This way, the exposure of the short and long integration time is proportional to the duration of their exposure times, and the requirement for the successful double exposure sensor is fulfilled. In the previous example, there were two exposure times. However, it is possible to have more than two exposures having lengths or t=1, t=2, . . . T=N. In such a case the overall energy of the flash pulse sets is linearly proportional to the exposure times.

FIG. 7 illustrates the solution where the exposure times T1, T2 overlap. The solution is the same as in the non-overlapping case of FIG. 6, but the correct duration of the exposure times T1, T2 has to be used.

To generalize the solution of dual xenon flash pulse sets is a case where the wide dynamic range is implemented using more than two integration periods (overlapping or non-overlapping). In this general case, the number of the flash pulses must be equal to the number of the integration periods and the energy in each of the pulses is linearly proportional to the duration of the integration period.

And to generalize the solution further, the total flash energy during each integration period is linearly proportional to the length of the integration period, but the number of the flash pulses is not limited to be the same as the number of the exposure times. An example of this kind of implementation would be, e.g. a system where flash is pulsed at constant frequency and power. If the flash pulse frequency is considerably higher than the length of the exposure time, the number of flash pulses occurring at each integration period is automatically proportional to the length of the integration period. Therefore, the overall flash energy during each integration time is also proportional to the length of the integration time.

In the previous, a solution for enhanced timing functionality has been describe with couple of example. The solution differentiates from the solutions of related art so that the shutter control signal (GRSTRDY Global Reset Ready) is internal to camera sensor. This requires less connections between the camera and the host, because the mechanical shutter can be controlled without synchronization signal between the host. The timer functionalities can also be used for controlling ND-filter or iris of the lens. This makes it possible to have smooth ND filter change during video recording, if synchronized to frame blanking. Flash strobe can be used with Xenon flash during mechanical shutter usage and with rolling shutter imaging. Flash strobe can also be used for synchronizing LED flash solution.

In the present solution low level (i.e. timer) and high level (i.e. state control) interfaces are presented. This makes it possible to have similar host behaviour regardless of whether there are multiple chips or single chip that use mechanical shutter, ND filter or iris of the lens. This gives better modularity which is important from the system point of view.

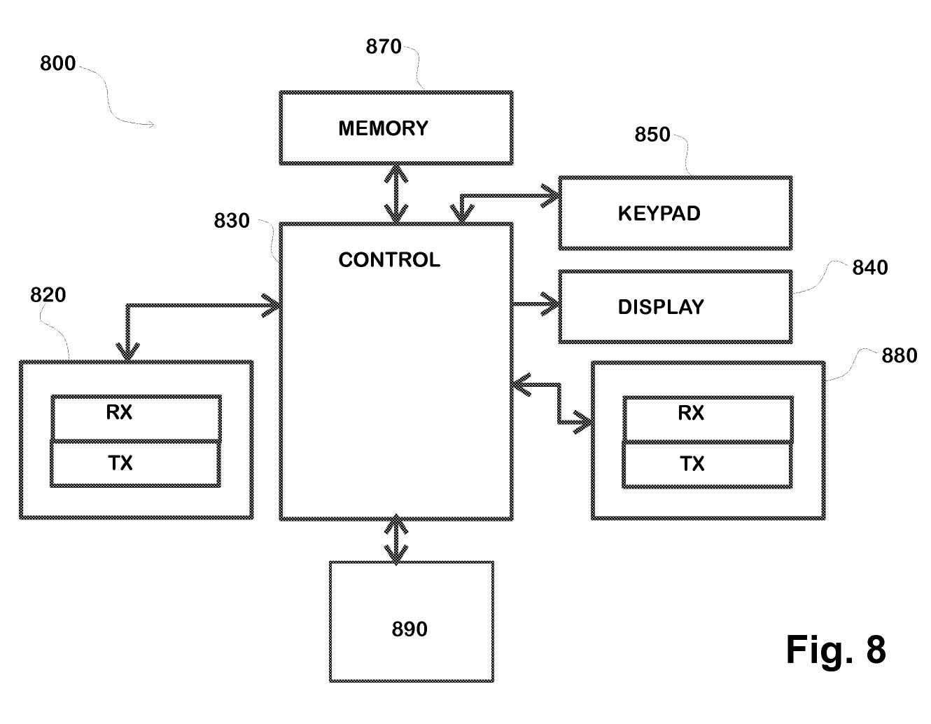

FIG. 8 illustrates an example of an apparatus, e.g. a mobile phone, where a camera system is configured. The apparatus 800 comprises a display 840 for displaying visual information e.g. a user interface, images. Further the apparatus 800 comprises a memory 870 that may store applications and various data etc. The apparatus may also comprise a keypad 850 for entering data or controlling the device 800.

The apparatus 800 comprises also a control unit 830 for controlling functions in the apparatus 800. The control unit 830 may comprise one or more processors (CPU, DSP). Yet further, the apparatus may comprises various communication means 820, 880 having a transmitter and a receiver. The first communicating means 820 can be adapted for telecommunication and the other communicating means 880 can be a one kind of short-range communicating means, such as Bluetooth™ system, WLAN system (Wireless Local Area Network) or other system which suits for local use and for communicating with another device.

The apparatus 800 can also comprise other means, such as audio means, including an earphone and a microphone and optionally a codec for coding (and decoding, if needed) the audio information. Further the apparatus comprises a camera system 890 as described above. Yet further the apparatus 800 can also operate with location/positioning systems, e.g. a GPS. The apparatus 800 can have other functionalities or can be connected to other computerized systems for enhancing the operation of the apparatus.

1-32. (canceled)

33. An apparatus comprising
a camera module comprising at least an image sensor and a shutter;
a host configured to control the camera module;
a flash
wherein
the image sensor is configured to define a first synchronization point triggering a first set of exposing functionalities by a sensor internal signal as a response to a first command, and
the camera module is configured to control the exposure internally according to said first synchronization point.

34. The apparatus according to claim 33, wherein the host is configured to send a second command defining a second synchronization point triggering a second set of exposing functionalities.

35. The apparatus according to claim 33, wherein a set of exposing functionalities comprises one or more of the following: global shutter, neutral density filter, iris of a lens, flash module.

36. The apparatus according to claim 33, wherein the camera module is configured to terminate a frame if the sensor receives a command between start of an image frame and end of the image frame.

37. The apparatus according to claim 33, wherein the flash is one of: a xenon flash or a LED flash.

38. The apparatus according to claim 33, configured to use at least two set of flash pulses for each frame, where the set of flash pulses consists at least one flash pulse.

39. The apparatus according to claim 33, where the shutter is one of the following: a rolling shutter, an electrical global shutter or a mechanical shutter.

40. An apparatus according to claim 33, being a mobile phone further comprising means for telecommunication.

41. A method comprising
defining a first synchronization point triggering a first set of exposing functionalities by an image sensor internal signal as a response to a first command,
controlling the exposure internally according to said first synchronization point.

42. The method according to claim 41, further comprising defining a second synchronization point triggering a second set of exposing functionalities.

43. The method according to claim 41, wherein a set of exposing functionalities comprises one or more of the following: global shutter, neutral density filter, iris of a lens, flash module.

44. The method according to claim 41, wherein said command is issued by a host device.

45. The method according to claim 44, comprising defining the time between the first and the second synchronization points by the host device.

46. The method according to claim 41, comprising terminating a frame if the image sensor receives a command between start of an image frame and end of the image frame.

47. The method according to claim 46, wherein a frame termination method depends on where the sensor may be in the frame that is being read out when the command is received.

48. The method according to claim 41, comprising using at least two set of flash pulses for each frame where set of flash pulse consists at least one flash pulse.

49. The method according to claim 48, wherein a first set of pulses is used for long exposure time and a second set of pulses is used for short exposure time.

50. The method according to claim 49, wherein the overall energy of the two set of pulses during each exposure time is proportional to the length of the exposure time.

51. The method according to claim 48, wherein the overall energy of said at least two set of flash pulses during one or more exposure times is linearly proportional to the length of exposure times.

52. A computer program product comprising executable instructions that, in response to execution by a processor, are adapted to perform
defining a first synchronization point triggering a first set of exposing functionalities by a sensor internal signal as a response to a first command,
controlling the exposure internally according to said first synchronization point.
